(19) United States
(12) Patent Application Publication
(10) Pub. No.: US 2003/0117283 A1
(43) Pub. Date: Jun. 26, 2003

(54) Encased security device

(76) Inventors: Stephen A. Elworthy, Merrimacport, MA (US); Robert A. Haley, Reading, MA (US)

Correspondence Address: CESARI AND MCKENNA, LLP, 88 BLACK FALCON AVENUE, BOSTON, MA, 02210, US

(21) Appl. No.: 10/036,630

(22) Filed: Dec. 21, 2001

(51) Int. Cl. G08B 13/14

(52) U.S. Cl. 340/572.8

(57) ABSTRACT

An encased security device includes a card shaped to define a peripheral flange and a pocket inboard the flange. A radio frequency identification tag is mounted to the card in the pocket and a plastic film is secured to the flange so as to span the pocket and enclose the tag. Securing means are provided for securing the device at the flange to an article.

### BACKGROUND OF THE INVENTION

This invention relates to a security device that is encased in an article being secured. The invention has particular application to the prevention of theft of articles of merchandise from stores or other points of display and sale of the merchandise.

Items of merchandise for sale are often secured to relatively large cards for display reasons and to inhibit theft. Often the cards have a security tag attached to the card. If a person tries to remove the article from the store without paying for it, a sensor at the store exit sounds an alarm. While the security tags may be magnetic or electromagnetic components, many security tags in use today are radio frequency identification (RFID) tags which include an integrated circuit chip and a tiny antenna which is tuned to transceivers strategically placed at the store exits. The transceivers send out an RF signal and if an RFID tag is present in a store item in the vicinity of the transceiver, the tag is sensed remotely by the transceiver which then may sound an alarm.

However it has been found that in the case of the more expensive items such as, for example, a heavy duty tape measure, thieves overcome that security measure by separating the product from the its display card using a razor blade or knife.

### SUMMARY OF THE INVENTION

The present invention aims to avoid the above problem by incorporating a security tag right in the product itself in such a way as to optimize the tag's response to the interrogating transceivers located at the store's exit points. The embedded security tag may be in addition to the one on the associated display card so that even if the thief cuts cut away the display card thinking he has avoided the security measure, when he tries to leave the store, he will still be caught because of the additional security tag encased or embedded in the product itself.

Most preferably, the security tag is placed under the product label or nameplate which is specially designed to accommodate the device and to optimize the tag's frequency response. As we shall see, this involves shaping the label or nameplate to form a recess sized to contain the RFID tag and covering the tag with a special film that has been found to enhance the electrical properties of the tag. By peeling away a backing sheet on the label or nameplate, the label or plate may be adhered to an article of merchandise. Preferably, the sales item is shaped so that the nameplate is recessed somewhat into that product making it difficult to remove the nameplate using a knife or the like. For added security, the label or nameplate may also be mechanically fastened to the product by rivets, screws or the like.

The encased security device can be made in quantity at a relatively low cost. Therefore, it should not add appreciably to the overall cost of the associated product.

### BRIEF DESCRIPTION OF THE DRAWINGS

For a fuller understanding of the nature and objects of the invention, reference should be made to the following detailed description taken in connection with the accompanied drawings, in which:

FIG. 1 is a perspective view showing a steel tape measure fitted with an encased security device incorporating the invention;

FIG. 2 is a sectional view on a larger scale taken along line 2-2 of FIG. 1, and

FIG. 3 is a plan view with parts broken away showing the reverse side of the encased security device in FIG. 1.

### DESCRIPTION OF THE PREFERRED EMBODIMENT

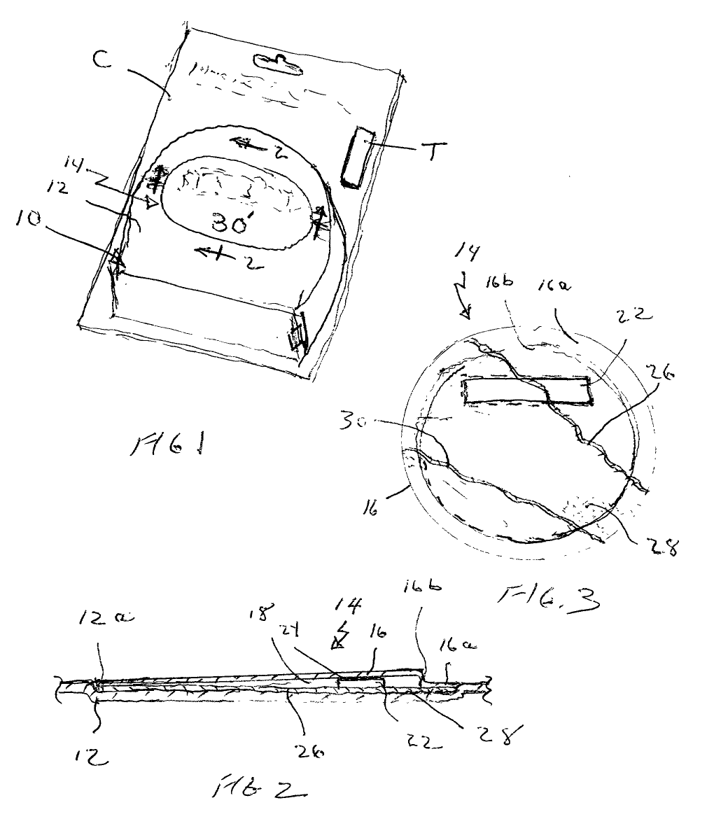

Refer now to FIG. 1 which shows a typical display card C having attached thereto a conventional security tag T. Shrink wrapped or otherwise secured to card C is an article of merchandise, i.e. a tape measure 10. Tape measure 10 has a front wall 12 to which is secured an encased security device shown generally at 14. Preferably the security device 14 is seated in a recess 12a formed in front wall 12 to make it more difficult to remove the security device from the tape measure 10.

Referring to FIGS. 2 and 3, the security device 14 comprises a relatively stiff card 16 made of a sturdy, weather-resistant material such as polyester or polycarbonate. Preferably the card 16 is molded or otherwise formed with a peripheral flange 16a and with at least a part of the card inboard that flange being raised as shown at 16b so as to define an interior cavity or pocket 18 which is large enough to contain a conventional radio frequency identification tag 22. Preferably, tag 22 is secured to the interior wall of card 16 by adhesive 24 or other suitable means.

It is a feature of this invention that the tag 22 is covered by a thin, i.e. 3 mil, plastic film 26. Film 26 is adhered to the card flange 16b so that the sheet spans the enclosure 18 and covers tag 22. Not only does film 26 protectively enclose tag 22, we have found that, for some reason not fully understood, if that sheet is of a polyester film, it enhances the performance of the RFID tag 22 so that the tag responds more readily to, and at a greater distance from, the transceivers which interrogate the tag. A particularly suitable film is marketed by Flexon Company, Spencer, Mass., under the designation SWITCHMARK 232.

The illustrated security device 14 is designed so that it can be adhered to wall 12 of tape measure 10 or to some other product. Hence, the device is provided with an adhesive coating 28 on the film 26 and a backing strip 30 over the adhesive. When the backing strip 30 is peeled away, the card 16 may be adhered to the tape measure wall 12 in recess 12a thereof.

Of course, rivets or screws could be driven through the card flange 16a into wall 12 to assuredly prevent removal of the security device from the tape measure.

It will thus be seen that the objects set forth above among those made apparent from the preceding description are efficiently attained. Also, since certain changes may be made in the above construction without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention described herein.

1. An encased security device comprising
a card shaped to define a peripheral flange and a pocket inboard the flange;
a radio frequency identification tag mounted to the card in said pocket;
a plastic film secured to the flange and spanning the pocket so as to enclose the tag, and
securing means for securing the device at said flange to an article.

2. The device according to claim 1 wherein the securing means comprise an adhesive coating on the exposed face of the plastic film.

3. The device according to claim 2 and further including a removable backing strip covering said adhesive coating.

4. The device according to claim 1 wherein the article has a wall with a recess therein, and the securing means secure the device so that the device seats snugly in said recess.

5. The device according to claim 1 wherein the film is a polyester film.

6. The device defined in claim 5 wherein the film has a thickness of about 3 mil.
